(19) United States
(12) Patent Application Publication
(10) Pub. No.: US 2024/0413362 A1
(43) Pub. Date: Dec. 12, 2024

(54) FUEL CELL SYSTEM, GAS TANK DEVICE, AND BLOCKING DEVICE FOR A GAS TANK DEVICE

(71) Applicant: Robert Bosch GmbH, Stuttgart (DE)

(72) Inventors: Udo Schaich, Stuttgart (DE); Andreas Rau, Stuttgart (DE)

(21) Appl. No.: 18/699,658

(22) PCT Filed: Sep. 26, 2022
(86) PCT No.: PCT/EP2022/076678

§ 371 Date: Apr. 9, 2024

(30) Foreign Application Priority Data
Oct. 20, 2021 (DE) 10 2021 211 815.1

(51) Int. Cl. H01M 8/04082; F16K 1/30; F16K 31/06; F16K 31/124; F17C 13/04

(52) U.S. Cl. CPC H01M 8/04201; F16K 1/30; F16K 31/0655; F16K 31/124; F17C 13/04; F17C 2205/0326; F17C 2205/0382

(57) ABSTRACT

The invention relates to a blocking device comprising a first connection for connecting to a high-pressure tank; a second connection for connecting to a supply line; a main valve chamber which comprises a first opening connected to the first connection in a fluidically conducting manner, a second opening connected to the second connection in a fluidically conducting manner, and a first control opening; a main valve, said main valve being designed as a switchable solenoid valve and comprising a main valve needle that is arranged in the main valve chamber and can be moved between a closed position, in which the main valve needle rests against a main valve seat surrounding the second opening, and an open position, in which the main valve needle is lifted from the main valve seat, wherein the main valve needle divides the main valve chamber into an outlet chamber, into which the first and second opening lead, and a control chamber, into which the first control opening leads and which is connected to the outlet chamber in a fluidically conducting manner; a servo valve chamber which is spatially separate from the main valve chamber and which comprises a second control opening connected to the first control opening in a fluidically conducting manner and a servo opening connected to the second connection in a fluidically conducting manner; and a servo valve, said servo valve being designed as a switchable solenoid valve and comprising a servo valve needle that is arranged in the servo valve chamber and can be moved between a closed position, in which the servo valve needle rests against a servo valve seat surrounding the servo opening, and an open position, in which the servo valve needle is lifted from the servo valve seat.

### BACKGROUND

The present invention relates to a fuel cell system, a gas tank device, in particular for a fuel cell system, and a blocking device for a gas tank device.

Fuel cell systems typically comprise a fuel cell arrangement, e.g., in the form of a stack comprising a plurality of electrically inline fuel cells supplied from a tank via a fuel supply line of gaseous fuel, e.g. hydrogen. In both stationary and mobile applications, such as in a vehicle, the gaseous fuel in the tank is typically at high-pressure, which can, e.g., be up to 700 bar or more. The tank thereby forms a high-pressure reservoir. The fuel is normally supplied to the fuel cell system at a lower pressure, e.g. at a pressure ranging from 2 bar to 20 bar. The fuel supply line can, e.g., be connected to the tank by a pressure control device, in which the pressure of the fuel is reduced. The line between the tank and the pressure control device is conventionally designed as a high-pressure line (hereinafter referred to as a supply line, as it supplies fuel to the fuel cell system). The tank is conventionally provided with a shut-off valve to block fuel leakage from the tank, e.g., when the fuel cell arrangement is taken out of service or in the event of a failure.

Shutoff valves for high-pressure gas tanks are normally designed as solenoid valves that are closed without current. Typically, a valve needle is biased against a sealing seat by a spring, and is detachable from the sealing seat by a magnetic force generated by a coil against the biasing force of the spring. Due to the high-pressure in the tank, high opening forces can be required depending on the valve design. This requires powerful coils and makes it difficult to miniaturize the valve.

DE 10 2006 027 712 A1 discloses a shut-off valve for a hydrogen pressure tank with a housing, comprising a first valve seat and a second valve seat, and a valve stem that can be moved through an electrical coil, which supports first and second sealing elements spaced apart on its outer circumference. In a closed position of the valve, the sealing elements are biased against the valve seats by a spring in order to seal an inlet from an outlet that is formed between the valve seats in the housing. The valve stem comprises a first opening which forms a fluidic connection between the inlet and a high-pressure side of the first sealing element. A closing force is thereby applied to the first sealing element as a result of the pressure that is applied to the inlet. The valve stem further comprises a through-hole connecting a secondary chamber located on a low-pressure side of the second sealing element to the inlet. An opening force is thereby applied to the second sealing element, that acts in the opposite direction to the closing force acting on the first sealing body. The aim of this design is to reduce a force acting on the valve stem or the sealing elements due to the pressure differential in order to reduce the opening force that must be generated by the electrical coil to open the valve.

### SUMMARY

Provided according to the invention is a blocking device for a gas tank device, a gas tank device, and a fuel cell system.

According to a first aspect of the invention, a blocking device for a gas tank device comprises a first connection for connecting to a high-pressure reservoir, a second connection for connecting to a supply line, a main valve chamber, which comprises a first opening connected to the first connection in a fluidically conducting manner, and a second opening connected to the second connection in a fluidically conducting manner, and a first control opening, a main valve, said main valve being designed as a switchable solenoid valve comprising a main valve needle that is arranged in the main valve chamber, which can be moved between a closed position in which the main valve needle rests against a main valve seat surrounding the second opening, to seal the second opening from the first opening, and an opening position in which the main valve needle is lifted from the main valve seat. The main valve needle divides the main valve chamber into an outlet chamber, into which the first and second opening lead, and a control chamber, into which the first and second opening lead and which is connected to the outlet chamber in a fluidically conducting manner.

The blocking device further comprises a servo valve chamber which is spatially separate from the main valve chamber and which comprises a second control opening connected to the first control opening in a fluidically conducting manner and a servo opening connected to the second connection in a fluidically conducting manner, and a servo valve, said servo valve being designed as a switchable solenoid valve and comprising a servo valve needle that is arranged in the servo valve chamber, which needle can be moved between a closed position, in which the servo valve needle rests against a servo valve seat surrounding the servo opening, in order to seal the servo opening with respect to the second control opening, and an open position, in which the servo valve needle is lifted from the servo valve seat.

Provided according to a second aspect of the invention is a gas tank device, in particular for a fuel cell system. The gas tank device according to the invention comprises a high-pressure gas tank for accommodating gas, e.g. hydrogen, and a blocking device according to the first aspect of the invention, the first connection of the blocking device being connected to an outlet opening of the high-pressure gas tank.

According to a third aspect of the invention, a fuel cell system comprises a fuel cell arrangement with at least one fuel cell, a fuel inlet for supplying gaseous fuel, an oxidation gas inlet for supplying oxidation gas and a product outlet for removing reaction products, a fuel supply line connected to the fuel inlet and a gas tank device according to the second aspect of the invention, the second connection of the blocking device being connected to the fuel supply line.

One idea underlying the invention is to provide a blocking device in which a main valve and a servo valve are arranged spatially separated from each other. In particular, a main valve needle is arranged in a first chamber or main valve chamber and can be moved between an open position and a closed position by means of a first coil, while a servo valve needle is arranged in a second chamber or servo valve chamber, which is arranged spatially from the main valve chamber and is connected to the latter in a fluidically conducting manner and can be moved between an open position and a closed position by means of a separate, second coil. The main valve needle is thereby displaceably guided in the first chamber and divides it into a control chamber, which connected to the second chamber in a fluidically conducting manner, and an outlet chamber, which comprises a first opening connected to a high-pressure connection or first connection and a second opening connected to a supply connection or second connection, which is covered or closed by the main valve needle when it is in the closed position. The second chamber is also connected to the supply connection in a fluidically conducting manner via a servo opening, which is covered or closed by the servo valve needle in its closed position.

One advantage of the invention is that the servo valve and main valve or their valve needles are housed in spatially separate chambers and can be moved by their own coils. This facilitates a space-optimized arrangement of the servo valve and main valve. By opening the servo valve, a fluidically conducting connection can be established between the second connection or the supply connection, which is intended for connection to a low-pressure reservoir such as the fuel supply line, and the control chamber of the main valve chamber with relatively little opening force. Given that the control chamber is connected in a fluidically conducting manner via the outlet chamber to the first connection or the high-pressure connection, which is intended for connection to a high-pressure tank such as the gas tank, pressure equalization takes place between the second connection and the control chamber. On the one hand, the pressure in the control chamber is reduced and, at the same time, the pressure in the second connection increases. As a result, a force is generated in the closed position of the main valve needle, which is directed away from the main valve seat and thus supports the main valve coil when the main valve needle is lifted from the main valve seat. As a result, the main valve coil can have smaller dimensions, which further facilitates miniaturization of the blocking device.

Advantageous embodiments and further developments follow from the additional dependent claims and from the description with reference to the figures in the drawings.

According to some embodiments, it can be provided that the main valve chamber and the servo valve chamber are formed in a common housing. Due to the spatially separate arrangement of the main valve chamber and the servo valve chamber in the housing, the valve needles can be oriented as desired relative to each other, which further facilitates a space-optimized arrangement or design.

According to some embodiments, it can be provided that the first control opening and the second control opening are connected by a connecting bore.

According to some embodiments, it can be provided that the fluidically conducting connection between the outlet chamber and the control chamber of the main valve chamber is dimensioned such that it acts as a choke for a fluid flow from the outlet chamber into the control chamber when the servo valve is open and the main valve is closed. As a result the pressure equalization between the outlet chamber and the control chamber is slowed down, thereby further increasing the opening force acting on the main valve needle.

According to some embodiments, it can be provided that the outlet chamber and the control chamber of the main valve chamber are connected to each other in a fluidically conducting manner via a bore in the main valve needle. According to alternative embodiments, it can be provided that the outlet chamber and the control chamber of the main valve chamber are connected to each other in a fluidically conducting manner by a gap formed between an outer circumference of the main valve needle and a wall surrounding the main valve chamber. The width of the gap can, e.g., be defined by the fit provided between the wall and the main valve needle, e.g. a clearance fit. However, the gap can also be formed only locally, e.g. by forming a groove in the wall and/or in the outer circumference of the valve needle. Simple and cost-effective connecting lines can thereby be created between the control chamber and the outlet chamber.

According to some embodiments, it can be provided that the main valve is designed as a solenoid valve that is closed without current and comprises a spring which biases the main valve needle into the closed position.

According to some embodiments, it can be provided that the servo valve is designed as a solenoid valve that is closed without current and comprises a spring which biases the servo valve needle into the closed position.

### BRIEF DESCRIPTION OF THE DRAWINGS

Some embodiments can provide for the blocking device to be accommodated in the outlet opening of the high-pressure gas tank.

The invention will be explained hereinafter with reference to the figures of the drawings. The drawings show:

FIG. 1 a schematic view of a hydraulic diagram of a fuel cell system according to an exemplary embodiment of the invention; and

FIG. 2 a schematic sectional view of a blocking device according to an embodiment of the invention.

### DETAILED DESCRIPTION

Unless otherwise stated, identical reference characters refer to identical or functionally identical components shown in the drawings.

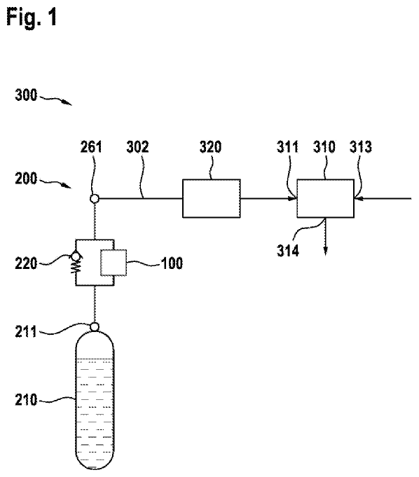

FIG. 1 shows an exemplary and schematic illustration of a fuel cell system 300. As schematically shown in FIG. 1, the fuel cell system 300 comprises a fuel cell arrangement 310, a fuel supply line 302, an optional pressure control device 320, and a gas tank device 200.

The fuel cell arrangement 310 is shown as a block only in FIG. 1, and comprises at least one fuel cell (not shown), a fuel inlet 311, an oxidation gas inlet 313, and a product outlet 314. The fuel cell arrangement can, e.g., comprise a plurality of serially electrically connected fuel cells, e.g., in the form of what is referred to as a stack. Each fuel cell comprises an anode, a cathode, and an electrolytic layer that is arranged between the anode and the cathode, e.g. in the form of a membrane. Via the fuel inlet 311, gaseous fuel, e.g. hydrogen, can be supplied to the anodes of the fuel cells. Similarly, oxidation gas, e.g. ambient air containing oxygen, can be supplied to the cathodes via the oxidation gas inlet 213 of the one or more fuel cells. The reaction products can be removed from the cathode via the product outlet 314. The at least one fuel cell is thereby configured to directly convert the chemical energy stored in the fuel into electrical energy together with oxidation gas.

The gas tank device 200 comprises a high-pressure gas tank 210 and a blocking device 100. The high-pressure gas tank 210 (hereinafter referred to merely as a tank for purposes of clarity) is, e.g., designed to receive gas, such as hydrogen, and can, e.g., store gas at a pressure of up to 700 bar. As shown schematically in FIG. 1, the tank 210 can, e.g., be designed as a substantially cylindrical tank. An outlet opening 211 of the tank 210 can, e.g., be arranged at an axial end of the tank 210. The blocking device 100 is merely symbolically shown in FIG. 1, and will be explained in detail hereinafter. As shown schematically in FIG. 1, the blocking device 100 is connected to the outlet opening 211 of the tank 210 and a low-pressure connection 261 of the gas tank device 200. Optionally, a check valve 220 can be switched in parallel to the blocking device 100, as shown by way of example in FIG. 1. The fuel supply line 302 connects the low-pressure connection 261 of the gas tank device 200 to the fuel inlet 311 of the fuel cell arrangements ‘310. The optional pressure control device 320 is arranged between the low-pressure connection 261 and the fuel inlet 311 in the fuel supply line 302, and is configured to reduce the pressure of gas flowing out of the tank 210 and/or vary the amount of flow. For example, the pressure control device 320 can comprise a flow-controllable choke valve.

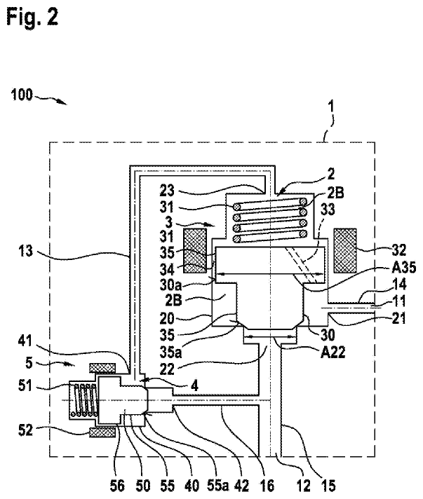

FIG. 2 shows a schematic and exemplary blocking device 100, as it can be installed in the gas tank device 200 in FIG. 1. As shown schematically in FIG. 2, the blocking device 100 comprises a first connection 11, a second connection 12, a main valve chamber 2, a main valve 3, a servo valve chamber 4, and a servo valve 5.

As shown in FIG. 2, the main valve chamber 2 and the servo valve chamber 4 are arranged spatially separated from each other. In general, the chambers 2, 4 each define a cavity which is bounded, e.g., by walls 20, 40. As shown purely schematically in FIG. 2, the main valve chamber 2 and the servo valve chamber 4 can be formed in a common housing 1.

The first connection 11 is provided for connecting to the high-pressure tank 210 and can, e.g., be designed as an opening or as a connection piece on the housing 1. The second connection 12 is provided for connecting to the supply line or the fuel supply line 302 and can also be designed as an opening or as a connection piece on the housing 1.

The main valve chamber 2 comprises a first opening 21, a second opening 22, and a first control opening 23. As shown in FIG. 2 by way of example, the first and second openings 21, 22 can each be formed in a first end region of the main valve chamber 2. For example, the first opening 21 can be formed on a circumferential wall, and the second opening 22 can be formed in a first end wall extending transversely to the circumferential wall, as shown by way of example in FIG. 2. In particular, the first control opening 23 can be formed in a second end region of the main valve chamber 2, e.g. in a second end wall opposite the first end wall, as shown in FIG. 2.

The first opening 21 is connected to the first connection 11 in a fluidically conducting manner, e.g. via a hole or line 14. The second opening 22 is connected to the second connection 12 in a fluidically conducting manner, e.g. via a hole or line 15, as shown in FIG. 2 by way of example.

As further shown in FIG. 2, the servo valve chamber 4 comprises a second control opening 41 and a servo opening 42. The servo opening 42 can, e.g., be formed in an end wall of the servo valve chamber 4, and the second control opening 41 can, e.g., be formed in a circumferential wall 40 extending transversely to the end wall, as shown by way of example in FIG. 2.

The first control opening 23 of the main valve chamber 2 and the second control opening of the servo valve chamber 4 are connected to each other in a fluidically conducting manner, e.g. via a bore or line 13, as shown schematically in FIG. 2. The servo opening 42 is connected in a fluidically conducting manner to the second connection 12, e.g. via a bore or line 16.

The main valve 3 is designed as a solenoid valve 3 that is closed without current and comprises a main valve needle 30, a spring 31, and a coil 32. The main valve needle 30 is arranged in the main valve chamber 2 and is axially displaceably guided on its outer circumference 30a by the wall 20, in particular the circumferential wall. As shown schematically in FIG. 2, the main valve needle 30 can, e.g., comprise a columnar or cylindrical main section 35 and a guide section 36, which projects radially from the main section 35 at a first axial end of said main section. A second axial end of the main section 35 comprises a sealing surface 35a, which can, e.g., be conical in shape. The guide section 36 can, e.g., feature a cylindrical outer circumferential surface which is guided on the wall 20.

As shown schematically in FIG. 2, the main valve needle 30 divides the main valve chamber 2 into an outlet chamber 2A and a control chamber 2B. For example, the guide section 36 can form a partition wall, as shown schematically in FIG. 2. The first and second openings 21, 22 each lead into the outlet chamber 2A. The first control opening 23 leads into the control chamber 2B. The control chamber 2B and the outlet chamber 2A are connected in a fluidically conducting manner, e.g. by a bore 33 formed in the main valve needle 30, in particular the guide section 36, or by a gap 34 formed between the outer circumference 30a of the main valve needle 30, in particular the outer circumference of the guide section 36, and the wall 20. The gap 34 is shown enlarged in FIG. 2 for reasons of clarity. For example, a width of the gap 34 can be given by the fit between the valve needle 30 and the bore diameter defined by the circumferential wall 20.

The main valve needle 30 can be moved between a closed position and an open position by means of the coil 32, which is arranged around the main valve needle 30, e.g. outside the main valve chamber 2. The spring 31 biases the main valve needle 30 into the closed position and can, e.g., be arranged in the control chamber 2B, as shown schematically in FIG. 2. FIG. 2 shows the closed position of the main valve needle 30. In the closed position, the main valve needle 30, in particular its sealing surface 35a, rests against a main valve seat surrounding the second opening 22 in order to seal the second opening 22 with respect to the first opening 21. In the open position, the main valve needle 30, in particular its sealing surface 35a, is lifted from the main valve seat so that fluid can flow from the first connection 11 into the outlet chamber 2A and through the second opening 22 to the second connection 12.

The servo valve 5 is likewise designed as a solenoid valve that is closed without current and comprises a servo valve needle 50, a spring 51, and a coil 352. The servo valve needle 50 is arranged in the servo valve chamber 4 and is axially displaceably guided on its outer circumference by the wall 40, in particular the circumferential wall. As shown schematically in FIG. 2, the servo valve needle 50 can, e.g., comprise a columnar or cylindrical main section 55 and a guide section 56, which projects radially from the main section 55 at a first axial end of said main section. A second axial end of the main section 55 comprises a sealing surface 55a, which can, e.g., be conical in shape. The guide section 56 can, e.g., comprise a cylindrical outer circumferential surface which is guided on the wall 40.

The servo valve needle 50 can be moved between a closed position and an open position by means of the coil 52, which is arranged around the servo valve needle 50, e.g. outside the servo valve chamber 4. The spring 51 biases the servo valve needle 50 into the closed position and can, e.g., be arranged in the servo valve chamber 4, as shown schematically in FIG. 2. FIG. 2 shows the closed position of the servo valve needle 50. In the closed position, the servo valve needle 50, in particular its sealing surface 55a, rests against a servo valve seat surrounding the servo opening 42 in order to seal the servo opening 42 with respect to the second control opening 41. In the open position, the servo valve needle 50, in particular its sealing surface 55a, is lifted away from the servo valve seat so that fluid can be exchanged through the servo valve chamber 4 via the second control opening 41 and the servo opening 42.

In the situation shown in FIG. 2, in which both the main valve 3 and the servo valve 5 are closed, the pressure present at the first connection 11 is present in the outlet chamber 2A, in the control chamber 2B and in the servo valve chamber 4. The main valve needle 3 features a first cross-sectional area A35 in a first end region facing the control chamber 2B. A second cross-sectional area A22 is defined by an area by which the main valve seat is circumscribed. As schematically shown in FIG. 2, the first cross-sectional area A35 is larger than a second cross-sectional area A22. If the pressure at the first connection 11 is greater than the pressure at the second connection 12, a compressive force acts in addition to the force applied by the spring 31 to the main valve needle 30, forcing the main valve needle 30 into its closed position.

To open the main valve 3, the servo valve 5 is first opened, i.e., the coil 52 of the servo valve 5 is energized in order to lift the servo valve needle 50 off the servo valve seat. The control chamber 2B is therefore connected to the pressure level of the second connection 12 in a fluidically conducting manner via the first and second control openings 23, 42 and the servo opening 42, which typically leads to a pressure reduction in the control chamber 2B. In general, pressure equalization takes place between the control chamber 2B and the second connection 12, which is why pressure equalization also takes place between the first control opening 23 and the second opening 22. As a result, the compressive force acting due to the different cross-sectional areas A35, A22 is increasingly reduced due to the pressure equalization. As a result, the magnetic force to be generated by energizing the coil 32 in order to move the main valve needle 35 into the open position is reduced. The fluidically conducting connection between the outlet chamber 2A and the control chamber 2B of the main valve chamber 2, e.g. the gap 34 or the bore 33, can in particular be dimensioned such that it acts as a choke for a fluid flow from the outlet chamber 2A into the control chamber 2B when the servo valve 5 is open and the main valve 3 is closed. This further reduces the magnetic force to be generated by energizing the coil 32 in order to move the main valve needle 35 into the open position.

Due to the spatially separate arrangement of the main valve chamber 2 and the servo valve chamber 4, the main valve and servo valve 3, 5 can be accommodated in a space-optimized manner. In particular, the main valve needle 30 and the servo valve needle 50 can extend relative to each other in any desired manner, which considerably increases the flexibility of the arrangement.

Although the present invention has been explained hereinabove with reference to exemplary embodiments, the invention is not limited thereto and can instead be modified in a variety of ways. Combinations of the exemplary embodiments hereinabove are in particular also conceivable. The blocking device 100 has been described by way of example in connection with a gas tank device 200 for a fuel cell system 300, but is not limited thereto. In principle, the blocking device 100 can be used in any desired gas pipeline system.

1. A blocking device (100) for a gas tank device (200), comprising:
a first connection (11) for connecting to a high-pressure tank (210);
a second connection (12) for connecting to a supply line (302);
a main valve chamber (2), which has a first opening (21) connected to the first connection (11) in a fluidically conducting manner, a second opening (22) connected to the second connection (12) in a fluidically conducting manner, and a first control opening (23);
a main valve (3) configured as a switchable solenoid valve and comprising a main valve needle (30) that is arranged in the main valve chamber (2) and can be moved between a closed position, in which the main valve needle (30) rests against a main valve seat surrounding the second opening (22) to seal the second opening (22) relative to the first opening (21), and an open position, in which the main valve needle is lifted from the main valve seat, wherein the main valve needle divides the main valve chamber (2) into an outlet chamber (2A), into which the first and second openings (21, 22) lead, and a control chamber (2B), into which the first control opening (23) leads and which is connected to the outlet chamber (2A) in a fluidically conducting manner;
a servo valve chamber (4) which is spatially separate from the main valve chamber (2) and which has a second control opening (41) connected to the first control opening (23) in a fluidically conducting manner and a servo opening (42) connected to the second connection (12) in a fluidically conducting manner; and
a servo valve (5) configured as a switchable solenoid valve and comprising a servo valve needle (50) that is arranged in the servo valve chamber (5) and can be moved between a closed position, in which the servo valve needle rests against a servo valve seat surrounding the servo opening (42) to seal the servo opening (42) relative to the second control opening (41), and an open position, in which the servo valve needle is lifted from the servo valve seat.

2. The blocking device (100) according to claim 1, wherein the main valve chamber (2) and the servo valve chamber (4) are formed in a common housing (1).

3. The blocking device (100) according to claim 2, wherein the first control opening (23) and the second control opening (41) are connected by a connecting bore (13).

4. The blocking device (100) according to claim 1, wherein the fluidically conducting connection between the outlet chamber (2A) and the control chamber (2B) of the main valve chamber (2) is dimensioned to act as a choke for a fluid flow from the outlet chamber (2A) into the control chamber (2B) when the servo valve (5) is open and the main valve (3) is closed.

5. The blocking device (100) according to claim 1, wherein the outlet chamber (2A) and the control chamber (2B) of the main valve chamber (2) are connected to each other in a fluidically conducting manner via a bore (33) in the main valve needle (30) or via a gap (34) formed between an outer circumference (30a) of the main valve needle (30) and a wall (20) delimiting the main valve chamber (2).

6. The blocking device (100) according to claim 1, wherein the main valve (3) is configured as a solenoid valve that is closed without current and comprises a spring (31), which biases the main valve needle (30) into the closed position.

7. The blocking device (100) according to claim 1, wherein the servo valve (5) is configured as a solenoid valve that is closed without current and comprises a spring (51), which biases the servo valve needle (50) into the closed position.

8. A gas tank device (200) comprising:
a high-pressure gas tank (210) for accommodating gas; and
a blocking device (100) according to claim 1;
wherein the first connection (11) of the blocking device (100) is connected to an outlet opening (211) of the high-pressure gas tank (210).

9. The gas tank device (200) according to claim 8, wherein the blocking device (100) is received in the outlet opening (211) of the high-pressure gas tank (210).

10. A fuel cell system (300), comprising:
a fuel cell arrangement (310) comprising at least one fuel cell, a fuel inlet (311) for supplying gaseous fuel, an oxidation gas inlet (313) for supplying oxidation gas, and a product outlet (314) for removing reaction products;
a fuel supply line (302) connected to the fuel inlet (311); and
a gas tank device (200) according to claim 8;
wherein the second connection (12) of the blocking device (100) is connected to the fuel supply line (302).

11. A fuel cell system (300), comprising:
a fuel cell arrangement (310) comprising at least one fuel cell, a fuel inlet (311) for supplying gaseous fuel, an oxidation gas inlet (313) for supplying oxidation gas, and a product outlet (314) for removing reaction products;
a fuel supply line (302) connected to the fuel inlet (311); and
a gas tank device (200) according to claim 9;
wherein the second connection (12) of the blocking device (100) is connected to the fuel supply line (302).

12. The gas tank device (200) according to claim 8, wherein the gas tank device (200) is part of a fuel cell system (300).
